(19) United States
(12) Patent Application Publication
(10) Pub. No.: US 2020/0238911 A1
(43) Pub. Date: Jul. 30, 2020

(54) AR ASSIST GLASSES FOR DRIING

(71) Applicants: FU DING PRECISION COMPONENT (SHEN ZHEN) CO., LTD., Shenzhen (CN); FOXCONN INTERCONNECT TECHNOLOGY LIMITED, Grand Cayman (KY)

(72) Inventor: CHUNG-NAN KO, New Taipei (TW)

(21) Appl. No.: 16/746,812

(22) Filed: Jan. 18, 2020

(30) Foreign Application Priority Data
Jan. 28, 2019 (CN) 201910077765.8

(51) Int. Cl. B60R 1/00; B60Q 9/00; G08G 1/16; G06F 3/01; G06F 3/0488; G02B 27/01

(52) U.S. Cl. CPC B60R 1/002; B60Q 9/00; G08G 1/168; G06F 3/012; G06F 3/04883; G02B 27/0172; G02B 2027/0138; B60R 2300/10; B60R 2300/202; B60R 2300/802; G02B 2027/0178; G02B 2027/0187; G02B 2027/0141; G02B 27/0179

(57) ABSTRACT

An AR assist glasses system for vehicles includes a MCU (Microcontroller Unit) linked respectively with a camera for taking the images, a display device for showing the images either from the camera or other existing driving assist systems, a wireless communication module for sending the images or information of the specific zone which the driver pays attention to, a gyroscope for detecting the displacement of the head of the driver to decide which specific zone the driver pays attention to, a wireless charging module for charging the battery, a touch control for inputting the control information, and a micro vibration motor for warning the driver.

### BACKGROUND OF THE DISCLOSURE

### 1. Field of the Disclosure

The present disclosure relates to an augmented assist glasses for driving, and particularly to supervision upon the driver's behavior and provision of the related information in response to the driver's behavior for safety.

### 2. Description of Related Arts

China Patent No. CN104090366A discloses a glasses for driving including a plurality of cameras installed around the car to send the images around the car to the glasses worn by the driver and indirectly into the eyes of the driver. Such a system lacks the wireless communication module so as not to efficiently exchange the information with the car system and the driver.

An efficient AR (Augmented Reality) assist glasses is desired.

### SUMMARY OF THE DISCLOSURE

An object of the invention is to provide an AR assist glasses system for vehicles with a MCU (Microcontroller Unit) linked respectively with a camera for taking the images, a display device for showing the images either from the camera or other existing driving assist system, a wireless communication module for sending the images or information of the specific zone which the driver pays attention to, a gyroscope for detecting the displacement of the head of the driver to decide which specific zone the driver pays attention to, a wireless charging module for charging the battery, a touch control for inputting the control information, and a micro vibration motor for warning the driver.

Other objects, advantages and novel features of the disclosure will become more apparent from the following detailed description when taken in conjunction with the accompanying drawings.

### BRIEF DESCRIPTION OF THE DRAWINGS

FIG. 1 is a diagram showing the modules used in the invention.

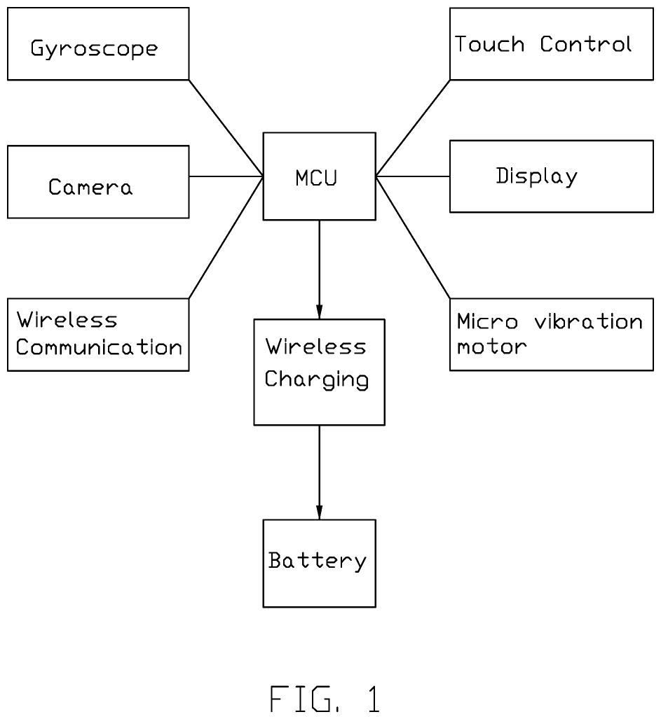

### DETAILED DESCRIPTION OF THE PREFERRED EMBODIMENT

An AR assist glasses system for aiding the parking assist system, the BSM (Blind Spot Monitor) system and the anti-collision system, includes a MCU linked respectively with the with a camera for taking the images, a display device for showing the images from either the camera or the other existing driving assist systems, e.g., the parking assist system or the BSM (Blind Spot Monitoring) system, a wireless communication module for sending the images or information in response to the specific zone which the driver pays attention to, a gyroscope for detecting the displacement of the head of the driver to decide which zone the driver pays attention to, a wireless charging module for charging the battery, a touch control for inputting the control information required by the driver, and a micro vibration motor for warning the driver. In this embodiment, a speaker to generate a sound for warning is provided.

In this embodiment, the interior space is divided into different zones including a windshield zone, the middle rearview mirror zone, the two side rearview mirror zone, the panel zone, the control panel zone, the audio/air conditioner zone, and the armrest zone. The gyroscope may detect the displacement of the driver's head to decide which specific zone the driver pays attention to, and through wireless communication with the MCU, the images reflecting the surroundings complying with such a specific zone are shown via the display, including the those in the blind spots thereof, thus assuring the driving safety. In other words, the blind spot of the right turn or the left turn or changing lane is no longer the problem.

The wireless communication module may connect the information of the mobile device and that restored by the car. When the driver is parking the car, the information derived from the parking assist system may be transmitted to the display via the MCU. Similarly, when the driver is back up the car, the rear side of the car via the original back-up assist system may be transferred to the display via MCU.

The micro vibration motor is for warning by slightly vibrating the driver's head in response to the abnormal behavior of the driver' head detected by the gyroscope or the abnormal eyesight captured by the camera. Notably, the warning sound can be generated by the speaker on the glasses. Understandably, the warning signal may be transmitted to the control panel of the car to induce the relatively significant warning effect including vibration of the steering wheel or sharp sound of the audio system of the car.

The wireless charging module may assure the battery operation.

While a preferred embodiment in accordance with the present disclosure has been shown and described, equivalent modifications and changes known to persons skilled in the art according to the spirit of the present disclosure are considered within the scope of the present disclosure as described in the appended claims.

What is claimed is:

1. An AR (Augmented Reality) assist glasses system for use with a driver operating a car, comprising:
a MCU (Microcontroller Unit) linked respectively with a camera for taking the images, a display device for showing images captured by the camera or other driving assist systems, a wireless communication module for sending the images or information of a specific zone which the driver pays attention to, a gyroscope for detecting displacement of the driver's head to decide the specific zone the driver pays attention to, a wireless charging module for charging the battery, and a micro vibration motor for warning the driver in response to an abnormal behavior of said driver.

2. The AR assist glasses system as claimed in claim 1, further including a speaker for generating a warning sound.

3. The AR assist system as claimed in claim 1, further including a touch control for inputting required control information via swinging gesture.

4. The AR assist glasses system as claimed in claim 1, wherein all the MCU, the camera, the display device, the wireless communication module, the gyroscope, the wireless charging module and the micro vibration motor are built on an AR assist glasses.

5. The AR assist glasses system as claimed in claim 1, wherein the driving assist system is a BSM (Blind Spot Monitoring) system.

6. A method of driving a car safely, comprising steps of:
providing an AR (Augmented Reality) assist glasses system with a MCU (Microcontroller Unit) linked respectively with a camera for taking the images, a display device for showing images captured by the camera or other driving assist systems, a wireless communication module for sending the images or information of a specific zone which the driver pays attention to, a gyroscope for detecting displacement of the driver's head to decide the specific zone the driver pays attention to, a wireless charging module for charging the battery, and a micro vibration motor for warning the driver in response to an abnormal behavior of said driver; wherein
the micro vibration motor operates when either the gyroscope or the camera detects an abnormal behavior of the driver.

7. The method as claimed 5, wherein the system further includes a speaker to generate a sound for warning.
